(19) United States
(12) Patent Application Publication
(10) Pub. No.: US 2011/0089100 A1
(43) Pub. Date: Apr. 21, 2011

(54) SELF CLEANING FILTER FOR LIQUIDS

(76) Inventors: Emmanuil Dermitzakis, Attikis (GR); Aristeidis Dermitzakis, Attikis (GR)

(21) Appl. No.: 12/999,056

(22) PCT Filed: Jun. 24, 2009
(86) PCT No.: PCT/GR09/00043

§ 371 Date: Dec. 14, 2010

(30) Foreign Application Priority Data
Jun. 24, 2008 (GE) 20080100417

(51) Int. Cl. B01D 29/62; B01D 29/15; B01D 29/50

(52) U.S. Cl. 210/298; 210/355; 210/332

(57) ABSTRACT

Self-cleaning filter for liquids with a basic element consisting of one cyclic elastic membrane 17 which covers completely the rims of a stable cavity 16. The rims of the cavity bear engraved shallow channels 25, while its concave part and bottom, bears great openings (26, 28). During the operation phase, the water passes under the membrane 17 and the shallow channels 25 of the cavity 16, leaves at the periphery of the rims or inside the channels the derbies 27 and through the openings 26 and 28 of the concave part and the bottom, comes out clean to the network 15 of the cleaned water. The water passing through the shallow channels 25, is subjected to a pressure loss with the result the membrane 17 to be significant bent, due to the pressure differences, and to be inserted sliding in to the cavity 16. By each interruption of the filter's operation, the membrane 17 returns in to its plan position scrapping and rejecting the derbies 27. For the cleaning and the final removing of the derbies, which are gradually coagulated, out of the filter, a flushing valve 24, during the operation and for a short interval of time, will be opened, and the greatest part of the water comes out to the environment, washing away and rejecting the derbies 27, which have been scrapped off. The same will happen by each start-up of the operation.

The present description relates to filters of liquids with the possibility of self cleaning of their elements in the beginning of each interruption or start-up of its operation.

### STATE OF THE ART

The EPO pat. 01923866.6 relates also to filters with the possibility of self cleaning during each interruption or start-up of their operation. Many disadvantages are observed in their configuration as well as in their operation:

The basic element of the cylindrical column is a very complex elastic circumferential channel of toroide or elongated shape with the characteristic Y cross section. The toroide Y consists of three independent distinguished parts, such as the substantial operational peripheral channel with two elongated peripheral filtration lanes and two independent auxiliary parts which are used, one of them, for the contraction and retraction of the toroide and the other for the support and its firm fixing.

The necessity of existence of all of these three parts, reduces substantially the ratio of the weight of the operational circumferential channel, vs. the total weight of the toroide element. Critical disadvantage, which in conjunction with the complex shape of the element which presupposes a complex, accurate and non productive molding process, increases substantially the total cost and the volume of the filter.

Other reasons of the extreme increase of the volume, are on one hand the significant clearance, height wise, between two successive fixed elements of the column/cage and on the other hand the cylindrical void space inside the column/cage.

As far as the operation is concerned, the cooperation of these three distinguished parts of the toroide Y, is a very difficult matter altogether. Problem of cooperation exists even between two opposite peripheral lanes of filtration of the operational channel which are laid on two different but parallel levels, which, at start-up of the operation, have to be contracted exactly uniformly and symmetrically in order to fit one another and to smallest in diameter corresponding lanes of the fixed elements of the cage.

The coincidence of the elastic and fixed elements cannot be reliable hence a simple hysteresis of a small magnitude during the bent or contraction of one part against another of the same lane, or a contortion of a part of the peripheral channel, is enough to annul the specific element. The water will pass through more specious and non controllable openings.

The conjunction of the complex geometrical shape and the elongated peripheral channel with the large cyclical void space in its center, allows an infinity number of freedom of movements and stability permutations to each diverse incompatible to each other constituents.

It is obvious that the plan auxiliary part of retraction of the element cannot be possible, due to its shape, neither to be contracted nor to be bent symmetrically and in a controlled manner. The very likely is to be deformed uncontrollably, resulting in a certain weakness of an unreliable cooperation with the peripheral operational channel. Same and rather stronger phenomena could be observed in the elongated channels of Y cross section of the same patent, where the problems and the cooperation with the systems of retraction, are much more intensive.

Unsymmetrical movement could be occurring as well as due to other less important reasons which for another simpler system, would be insignificant. Such are the non uniformity of the thickness or of the quality of the plastic material or the variation in a certain place of the friction's coefficient between elastic and fixed element.

Another disadvantage occurs due to the considerable pressure which is necessary for starting-up of the contraction of the toroide, resulting to inoperable conditions at low water pressure ranges.

It constitutes a disadvantage the fact that the magnitude of the movement or the drift of the movable operational filtration surfaces in relation with the fixed surfaces of the cage, is equal to the value of the radial contraction of the toroide itself, which contraction due to its geometry, is very small and corresponds to a very small percentage of the toroide's radius. This is a significant parameter which degrades the efficiency of the system.

### BRIEF DESCRIPTION OF THE INVENTION

The basic element of the new filter consists of a small, plan, and pre-stressed cyclic, elastic membrane which covers completely the rims of one hemispherical cavity. The rims of the hemispherical cavity, bear engraved shallow channels, almost radial positioned, while its concave part and its bottom bear large openings. The dimensions and the geometry of the shallow channels characterize the mesh-size and the quality of the filtration of the liquid.

During the operation phase, the water passes under the membrane and the shallow channels of the rims of the cavity, leaving the derbies at the circumference of the rims or into the shallow channels itself and through the openings of the cavity and the bottom, comes to the cleaned water network.

The water passing through the narrow and shallow channels, is subjected to a pressure loss resulting to a significant bent of the membrane due to the pressure difference developed between the two surfaces and to insert and sink sliding into the interior of the cavity, widening at the same time the surface of its coverage's and its contact's with the shallow channels.

By each interruption of the operation of the filter, the membrane returns back in its plan position, scraping due to its relative movement against the fixed cavity and rejecting the foreign bodies.

Rejecting of the foreign bodies occurs also by each start-up of the operation of the filter due to the sliding of the membrane over the rims of the cavity during its bent. The rejection occurs towards the space which is located before the cavity and the derbies remain initially inside the filter, but without creating any direct problem to its operation.

For the cleaning and the final removal of the derbies from the interior of the filter which are gradually coagulate, a flushing valve will be opened during the operation and for a sort interval of time and the greatest amount of the available water deviates and comes out to the environment washing away the derbies.

By closing of the flushing valve, the amount of the water which is deviated for the cleaning purposes returns back to the stream of the normal operation. The magnitude of flushing will be enhanced with the partial or total interruption of the cleaned water supply to the network.

The filter bears at the water inlet an incorporated pro-filter for the initial trapping of the big in dimension foreign bodies. The pro-filter will be cleaned by the opening of another flushing valve of small size.

### DESCRIPTIONS OF THE DRAWINGS

FIG. 1. illustrates the cross-section of the assembled filter and its operation.

FIG. 2. illustrates the plan view of the filter as it looks after removing the cover part.

FIG. 3. illustrates the plan view of the basis body of the filter.

FIG. 4. illustrates the plan view of the mediate reparative diaphragm of the filter.

FIG. 5. illustrates the cross section of a detail of the basic element among with the elastic membrane.

FIG. 6. illustrates the plan view of a detail of the basic element of the FIG. 5.

FIG. 7. illustrates the detail of the basic element of the FIG. 5. during the normal operation phase.

FIG. 8. illustrates a view of the basic cassette of filter.

FIG. 9. illustrates a side view of the basic cassette of filter of the FIG. 8.

FIG. 10. illustrates a plan view of the basic cassette of filter of the FIG. 8.

### DETAILED DESCRIPTION OF THE INVENTION

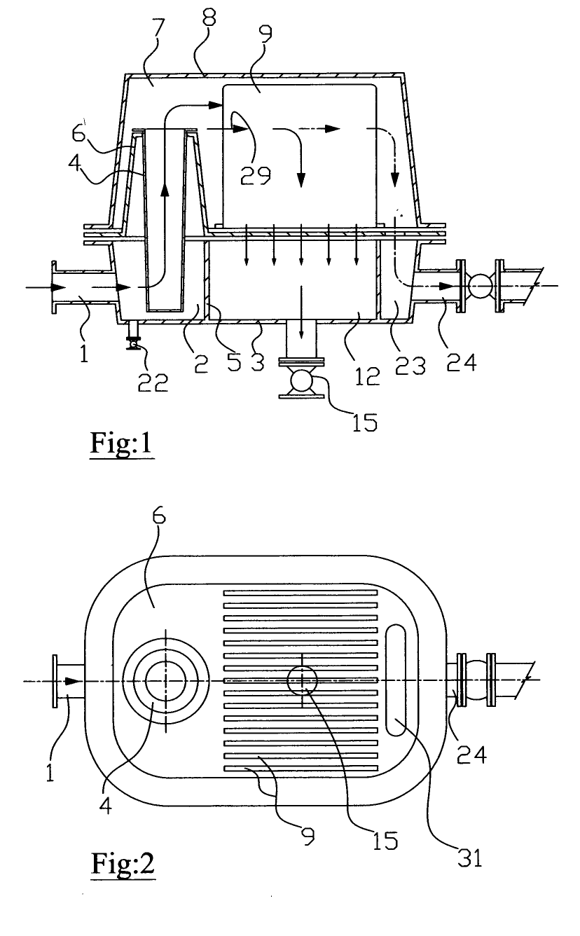

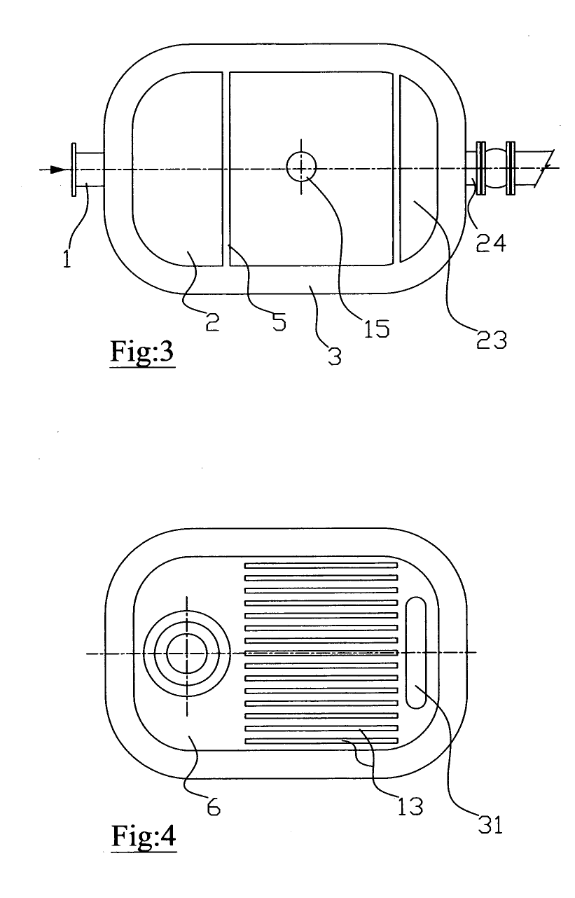

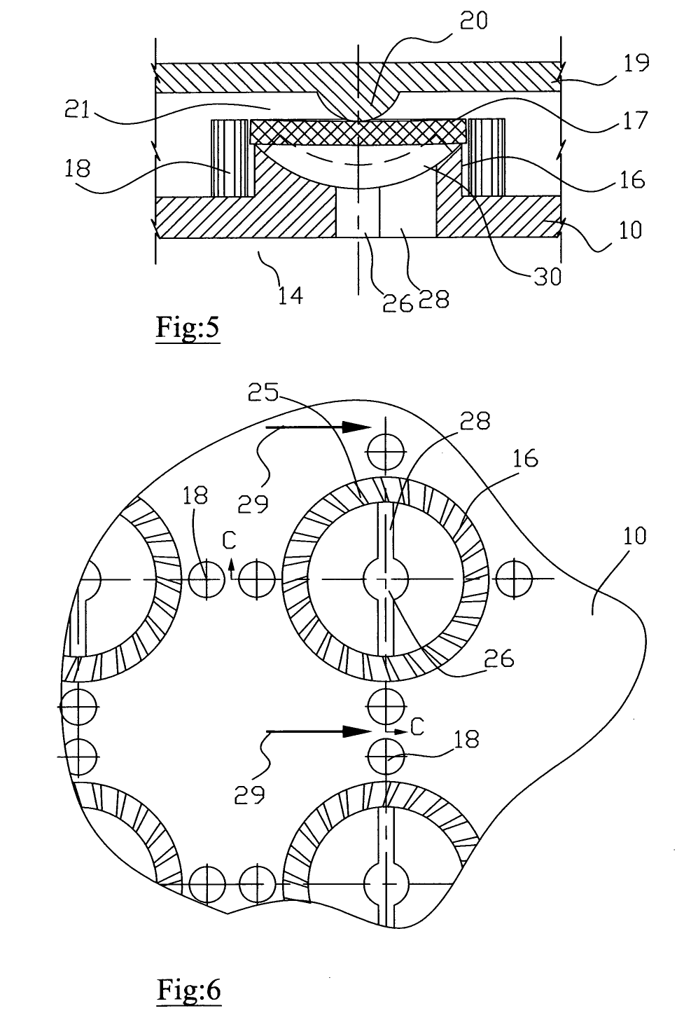

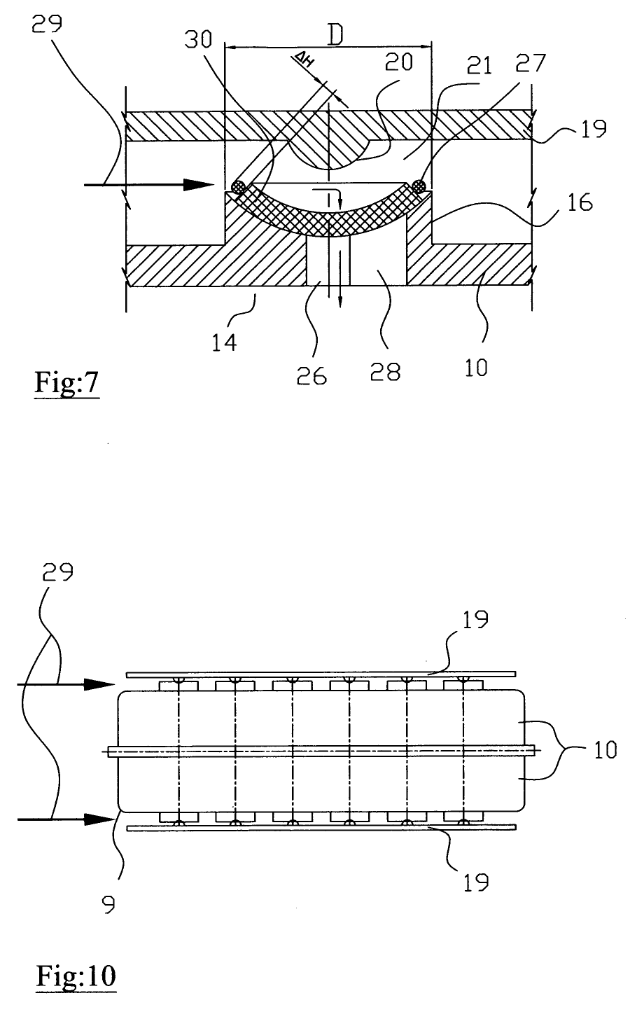

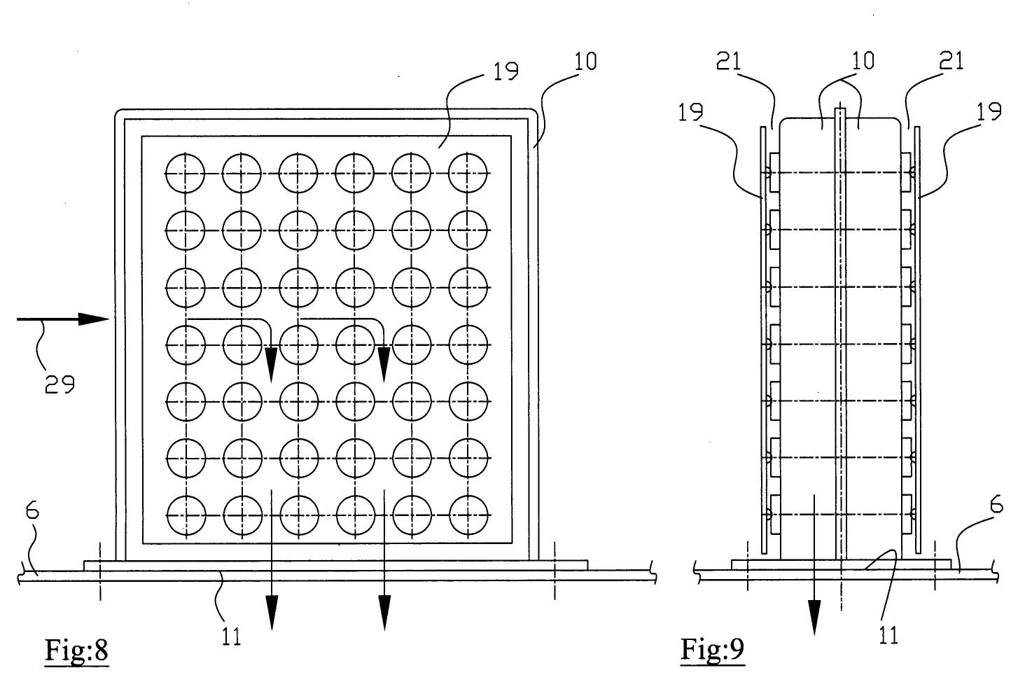

At FIGS. 1,2,3 & 4, the water or the liquid enters through the inlet 1 into the area 2 of the pro-filter 4 which is created at the beginning of the basic body 3 of the filter confined between the diaphragm 5 of the basic body 3 and the mediate reparative diaphragm 6 of the filter. Through the pro-filter 4 the water enters in the area 7 created between the basic cover part 8 of the filter and the mediate reparative diaphragm 6. The cylindrical pro-filter 4 is designed for the initial trapping of the very big in dimension or for the elongated derbies and is based on the reparative diaphragm 6 which is located between the body 3 and the cover part 8 of the filter. The derbies are gathered at the external convex surface of the pro-filter 4, and in the bottom of the space 2 and are flushed out by opening of the valve 22 at frequent intervals of time during the normal operation of the filter.

The water after the pro-filter 4, and through the indiscrete space 7, passes through the main filtering space which comprises of the parallel attached cassettes 9, containing the basic filtering elements as they are shown in FIGS. 6,7,8,9 and 10. The cassette 9 comprises of two flat rectangular cover parts 10 with bent the three of the four of their sides, which are butt-fusion welded parallel along their opposite bent sides, creating a closed parallelepiped and narrow box of small volume, open only at the underside 11. With this open side 11, the cassette 9 is based on the corresponding opening 13 of the mediate reparative diaphragm 6. Through the same opening 13, the cleaned water passes freely from the interior 14 of the cassette to the space 12 of the basic body 3 and from there, by opening of the valve 15, to the clean water main supply network after it's been cleaned according to the system described bellow. The basic body 3 comprises another third independent space 23 that will be used for the flushing phase, which connects the filter with the environment through the valve 24.

The rectangular cover parts 10 bears at regular distances a plurality of almost hemispherical cavities 16 which are slightly protruded and are fully covered by a corresponding plurality of flat circular elastic membranes 17. On the surfaces of the cover parts 10 and in contact to the cavities 16, builds-up a plurality from vertical and parallel to each other cylindrical or prismatic protrusions 18 which holds the membranes 17 in the desirable position exactly over the cavities 16.

Parallel to the rectangular cover parts 10, the cassettes 9 are also covered, from both sides (left and right) along the whole external surface, and from two other flat secondary external cover parts 19 which bears at certain distances corresponding to the center of the cavities 16, a plurality of small hemispherical protrusions 20 which corresponds to the centers of the membranes 17 and bear a slight pre-stress on to the membrane 17, bending it slightly and permanently, in order the cavity 16 to be kept completely covered. The whole system of the cassette 9 with both the rectangular surfaces 10, the elastic membranes 17 and the secondary external cover parts 19, consist a single unity.

The cassettes 9 are poisoned with their large flat surfaces parallel to the direction of the motion of the water 29, next to the other almost without any space left, with the external cover part 19 of the one, almost in contact to the other.

The water enters from the unified space 7 of the cassettes, passing through the single free clearances which are the narrow clearances 21, which develop on both sides between the cover parts 10 and 19 of the cassettes 9. During the normal operational phase of the filter, the valve 15 is open, connecting the clean water outlet with the network of the cleaned water, while on the contrary, the flushing water outlet and the corresponding valve 24 remain closed.

The rim of the lip of the almost hemispherical cavity 16 lies at a level and bears shallow almost radial channels 25, of gradual reduced cross-section towards the center, while its concave part bears great openings (26,28).

Apart from the opening 26 in the center of the cavity 16, exists an other elongated opening 28 which crosses over diametrically the cavity 16 along with the whole opening 26 and ends just before the rims and the shallow channels 25. This elongated channel is positioned vertically towards the horizontal motion 29 of the water as it is shown inside the clearance 21 of the cassette 9 and has a direction towards the free and open basis 11 of the cassette 9.

During the operation phase, the water passes under the membrane 17 and the shallow channels 25 of the rims of the cavity 16, leaving the derbies 27 in the circumference of the rim or inside the shallow channels 25 and through the openings 26 and 28 of the cavity, and travels to the interior of the cassette 9, the space 14 and from there in to the space 12 and through the valve 15, to the cleaned water or liquid network.

The dimensions and the geometry of the shallow channels 25 through which passes the clean water, characterize the mesh size and quality of the filtration.

The water while passing through the narrow and shallow channels 25, is subjected to a pressure loss, resulting the membrane 17 to be drawn and bent substantially due to the pressure differences which are developed between its two surfaces and to be inserted gliding at the value of 2*ΔH in the interior of the cavity 16, taking almost the shape of the concave form 30, widening the covering and contact surface with the shallow channels 25, which entails at the same time the general widening of the filtering area as well as the optimization and the working dept.

The total value 2*ΔH of the sliding of the membrane 17 in the marginal case where the membrane inserts and occupies the whole concave part 30 of the hemispherical cavity 16, measured in length units and as a percentage of the radius r or D/2 of the cavity, is equal to the differences of the sizes:

2*ΔH=π*r−2r=r*(π−2)\acute{η},π*D/2−D=D/2*(π−2).

The relation shows the difference of the development of a hemi periphery in relation to the diameter D of the same cycle that in the present case represent in cross section the first of them the cavity 30 and the second the plan membrane 17 which covers it.

The sliding of the membrane 17, as an absolute or relative size, has, as it is shown, a very high value and compared to the corresponding values of the known toroid-like elements, is by far more intense. It is clear that the size of sliding characterize the efficiency of the self-cleaning capability of the filter.

The development of the active periphery π*D of the membrane 17 in relation to the weight of the elastic material, is much more higher compared to the corresponding active peripheries of the toroid-like elements. The same holds also by the comparison of the corresponding volumes of the columns-cages with the void space in their center on the one hand, to the narrow flat cassettes 9 on the other, related in both cases with the same active filtration's surface.

Furthermore the membrane will be produced easily and cheaply, its bent and return are absolutely predetermined, symmetrical and predictable movements and the bent in general, in contrary to clean contraction of the toroid, needs a minimal pressure for operation and acts direct.

By every interruption of the operation of the filter, membrane 17 returns back in to the plan position scraping and rejecting the derbies with the relative motion of its circumference surface against the fixed cavity.

The scraping of the derbies 27 will be created also by every start-up of the operation of the filter with a total glide value of 2*ΔH of the membrane 17 in the reverse direction over the rim of the cavity 16.

The flushing of the debris 27 on both cases is performed towards the space 21 before the cavity 16, while the debris 27 remain within the filter at the bottom of the space 21 without causing directly any disturbance in the operation of the filter, since the specific space is not connected directly with the space 12 of the clean water.

For the cleaning and the final flushing from the filter of the derbies 27 that gradually coagulate in the space 21, opens during operation for short periods of time the flushing valve 24 and the greater part of the water due to the differences of the hydraulic resistances, is diverted from opening 31 to space 23 and exits to the environment along with the debris 27.

With the closing of the valve 24, the part of the water that was diverted for cleaning, returns in the flow of the normal operation. The intensity of cleaning is enhanced with the semi or complete stopping of the flow 15 of clean water towards the corresponding main water network. The motion of the water at the phase of the final flushing of the debris towards the exit 24, is indicated with a dashed line.

Alternatively there could exist shallow radial channels 25 curved both at the perimeter of the elastic membrane 17, which in this case should be orientated and inclined differently towards the fixed shallow channels 25 of the cavity 16. i.e. clockwise against counterclockwise orientation, thus when the two facing surfaces match, their engraved channels would not coexist or completely identify the one upon the other but rather to cross each other. It has not been designed.

At another variation there could exist also shallow circular co-centric peripheral channels of constant though diameter curved in the perimeter of the elastic membrane 17. It has not been designed.

At another variation there could exist shallow channels, apart from those in the section of the rims, at the entire concave part of the cavity 16 increasing the surface and depth of operation of the filter. It has not been designed. At other variations the outer design of the rims could have an elliptical or other form with corresponding formation of the concave part, or the membrane would not be flat and of the same thickness bearing fixing parts. They have not been designed.

At other variations the cassette 9 or the body 3 and the cover 8 could have a cylindrical or other form of a solid body, as it could also the inlet 1 of the water to have such direction and the body 3 such a form, thus the water in space 2 to form a hydro-cyclone around the pre-filter 4 cleaning it constantly from the outside. They have not been designed. At other variations there could exist in several places of the filter such as i.e. at the direction changes of the water, fixed guides, fins for the proper distribution of the water currents and the better cleaning at the phase of flushing. We specifically notice that the water in its primary motion inside the space 21 it could do instead of one as indicated in the drawings, two or three consecutive forced turns before it exits from the opening 31 in space 23 of the cleaning thus to increase similarly the velocity and intensity of flushing at space 21. They have not been designed.

1. Self-cleaning filter for liquids consisting of an elastic membrane covering completely the rims of a fixed cavity which bears engraved shallow channels, while the concave part and the bottom of the cavity bears openings, where during the operational phase, the water, passes under the elastic membrane and through the shallow channels, leaving the derbies in to the shallow channels, and through the openings, goes cleaned to the network of the cleaned water, where the water passing through the shallow channel is subjected to a pressure loss resulting to a bent and inserting of the membrane in to the cavity where by each interruption of the operation of the filter, the membrane returns rejecting the derbies characterized by that the membrane is flat.

2. Self-cleaning filter for liquids according to claim 1 characterized by that the cavities are almost hemispherical.

3. Self-cleaning filter for liquids according to claim 1 characterized by that the elastic membrane is slightly pre-stressed under the pressure of a protrusion.

4. Self-cleaning filter for liquids according to claim 1 where the cavities with the membranes are laid and slightly protruded on the plan surface of the rectangular cover parts.

5. Self-cleaning filter for liquids according to claim 1, where the rectangular cover parts at instances of two at a time and opposite to each other comprise a united cassette.

6. Self-cleaning filter for liquids according to claim 1, where the positions of the membrane are defined and held on the rectangular cover parts from vertical and parallel to each other prismatic protrusions.

7. Self-cleaning filter for liquids according to claim 1 where for the flushing and the final removal of the derbies from the filter, will be opened during the operation and for a short intervals of time, a flushing valve.

8. Self-cleaning filter for liquids according to claim 1 where at the filter inlet a pro-filter will be interposed.

9. Self-cleaning filter for liquids according to claim 1 where the pro-filter has in addition and hyrocyclone capability.

10. Self-cleaning filter for liquids according to claim 1, where the bottom of the cavity bears elongated diametrical openings.

11. Self-cleaning filter for liquids according to claim 1 where the membrane bears engraved shallow almost radial channels.

12. Self-cleaning filter for liquids according to claim 1 where at particular places of the filter guiding vanes exist increasing the length of the path of the flushing water.

13. Self-cleaning filter for liquids according to claim 1 where the contour of the rims of the cavity has ellipsoid or another form with a corresponding formation of the cavity and the membrane.

14. Self-cleaning filter for liquids according to claim 1 where shallow channels covers also the concave part of the cavity.

15. Self-cleaning filter for liquids according to claim 1 where the membrane bears fixing parts.

16. Self-cleaning filter for liquids according to claim 1 where the membrane has not an equal thickness.
